(19) United States
(12) Patent Application Publication
(10) Pub. No.: US 2010/0239018 A1
(43) Pub. Date: Sep. 23, 2010

(54) VIDEO PROCESSING METHOD AND VIDEO PROCESSOR

(75) Inventors: Yu-Wei Chang, Hsinchu City (TW); Chao-Tsung Huang, Kaohsiung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: Novatek Microelectronics Corp., Hsinchu (TW)

(21) Appl. No.: 12/468,061

(22) Filed: May 19, 2009

(30) Foreign Application Priority Data
Mar. 17, 2009 (TW) 98108620

(51) Int. Cl. H04N 7/32; H04N 7/26

(52) U.S. Cl. 375/240.16; 375/240.12; 375/E07.125

(57) ABSTRACT

A video processing method and a video processor are disclosed. The video processor includes a processing device, and the video processor is coupled to a buffer. The video processor reads a plurality of current frames to be coded and a plurality of search windows, and performs motion estimation on a plurality of macroblocks (MBs), wherein the MBs are co-located within the current frames to be coded and the current frames to be coded have no data dependence on each other.

### CROSS-REFERENCE TO RELATED APPLICATION

This application claims the priority benefit of Taiwan application serial no. 98108620, filed on Mar. 17, 2009. The entirety of the above-mentioned patent application is hereby incorporated by reference herein and made a part of specification.

### BACKGROUND OF THE INVENTION

1. Field of the Invention

The present invention generally relates to a video processing method and a video processor, and more particularly, to a video compression method and a video compression processor.

2. Description of Related Art

With the conventional video processing methods, every frame of a video stream is decomposed into a plurality of macroblocks (MBs), and an entire compression program is decomposed into a plurality of stages. Each stage herein is in charge of dealing with different compression programs, such as motion estimation, discrete cosine transform (DCT), variable length coding (VLC), reconstruction, and so on. In this way, a video processor can be designed as a plurality of processing devices, and each processing device is in charge of processing a corresponding stage. In more details, the above-mentioned processing devices of a video processor can be respectively designed into a pipelined hardware structure, where each processing device serves as a pipeline stage, so that when the video processor executes video processing, the MBs of a same frame are sequentially transmitted to the above-mentioned plurality of the processing devices. When each of the pipeline stage has processed a stage of the compression program required for an MB, the processed data is transmitted to the next pipeline stage. Based on the described above, the pipeline stage able to process an MB is termed as an MB pipeline and each stage is termed as an MB stage.

During a video processing course, the above-mentioned motion estimation functions to define a range of a search window in a reference frame according to the position of an MB in a current frame to be coded, and to find out a reference MB within the search window, wherein the reference MB has the minimum difference from the MB. The shift value of the MB relative to the reference MB is defined as a motion vector. It can be seen that the processing device in charge of motion estimation processing in a pipeline stage needs to tremendously access a memory for reading and writing data. As a result, the bandwidth of a memory used for motion estimation processing plays a critical role. Furthermore, a conventional video processor is disadvantageous in limiting the compression processing onto a single frame only, failing to perform compression processing on a plurality of frames simultaneously, and failing to save the bandwidth of a memory used for motion estimation processing during tremendously accessing a memory for reading and writing data.

### SUMMARY OF THE INVENTION

Accordingly, an exemplary embodiment of the present invention is directed to a video processing method and a video processor, wherein the video processor is coupled to a buffer, the video processor reads a plurality of current frames to be coded and a plurality of search windows, and a processing device in the video processor performs motion estimation on a plurality of MBs. The MBs herein within the corresponding frames to be coded occupy the positions same as each other; or briefly, the MBs are co-located.

An exemplary embodiment of the present invention provides a video processor, which includes a processing device and an image encoder, wherein the processing device is for reading a plurality of MBs from each of a plurality of current frames to be coded, the image encoder is for receiving the above-mentioned MBs and performing coding processing, and the MBs are co-located respectively within the corresponding current frames to be coded.

An exemplary embodiment of the present invention provides a video processing method, which includes following steps: (a) reading a plurality of current frames to be coded from a buffer, wherein each current frame to be coded includes a plurality of MBs; (b) reading k search windows from the buffer, wherein x is a positive integer greater than 0; (c) in a processing device, performing motion estimation within the x search windows on the m-th MB of the i-th current frame to be coded of the current frames to be coded; (d) in the processing device, performing motion estimation within the x search windows on the n-th MB of the j-th current frame to be coded of the current frames to be coded.

In an exemplary embodiment of the present invention, the integer i is not equal to j.

In an exemplary embodiment of the present invention, the m-th MB within the i-th current frame to be coded and the n-th MB within the j-th current frame are co-located.

In an exemplary embodiment of the present invention, the current frames to be coded have no data dependence on each other.

In an exemplary embodiment of the present invention, the motion estimation is used to obtain a plurality of reference MBs and a plurality of motion vectors corresponding to the MBs.

In an exemplary embodiment of the present invention, the above-mentioned step (c) includes following steps: (e) using the processing device to search a reference MB within the x search windows, wherein the difference value between the reference MB and the m-th MB is the minimum; (f) calculating a motion vector, wherein the motion vector is a shift value of the m-th MB relative to the reference MB.

In an exemplary embodiment of the present invention, the video processing method further includes repeatedly executing the step cycle from step (b) to step (d).

In an exemplary embodiment of the present invention, the current frames to be coded are a plurality of B frames, a plurality of P frames or a plurality of combinations thereof.

An exemplary embodiment of the present invention provides a video processor, which is coupled to a buffer, wherein the video processor reads a plurality of current frames to be coded from the buffer, and each of the current frames to be coded includes a plurality of MBs. The video processor includes a memory device and a processing device. The memory device is for reading x search windows from the buffer, wherein x is a positive integer greater than zero. The processing devices is for performing motion estimation within the x search windows on the m-th MB of the i-th current frame to be coded of the current frames to be coded, and is also for performing motion estimation within the x search windows on the n-th MB of the j-th current frame to be coded of the current frames to be coded.

An exemplary embodiment of the present invention provides a video processing method, which includes following steps: (a) reading the i-th macroblock of each of p current frames to be coded by a processing device, wherein each of the current frames to be coded comprises a plurality of macroblocks and p is a positive integer greater than 1; (b) transmitting the i-th macroblocks to an image encoder.

In an exemplary embodiment of the present invention, the i-th macroblock within each of the current frames to be coded is co-located as those within the other current frames to be coded.

In an exemplary embodiment of the present invention, the video processing method further includes following steps: (c) reading x search windows by the processing device, wherein x is a positive integer greater than zero; (d) in the image encoder, performing motion estimation on the i-th macroblocks within the x search windows.

In an exemplary embodiment of the present invention, the video processing method further includes repeatedly executing the step cycle from step (a) to step (b).

An exemplary embodiment of the present invention provides a video processor, which includes a processing device and an image encoder. The processing device herein is for reading the i-th MB from each of p current frames to be coded, wherein each of the current frames to be coded includes a plurality of MBs and p is a positive integer greater than 1. The image encoder herein is for receiving the i-th MBs and performing image coding processing.

Based on the described above, in the video processing method and the video processor of the present invention, since the plurality of MBs within a plurality of current frames to be coded are co-located, so that during designing motion estimation, the buffer is needed to read a plurality of search windows once to meet the requirement by the MBs for performing motion estimation. In addition, since the video processor is designed as a plurality of pipelined processing devices, so that the processing devices can efficiently and simultaneously execute individual functions in a unit time, which is advantageous in not only saving the memory bandwidth of motion estimation, but also simultaneously processing a plurality of frames.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a diagram for decomposing a frame into a plurality of MBs.

FIG. 2 is a diagram showing the stages of the main program for video processing.

FIG. 3 is a diagram illustrating motion estimation.

FIG. 4 is a diagram showing the video processing method on progressive frames according to an exemplary embodiment of the present invention.

FIG. 5 is a block diagram of a video processor according to an exemplary embodiment of the present invention.

FIG. 6 is a timing diagram of the pipeline stages of a video processor according to an exemplary embodiment of the present invention.

FIG. 7 is a diagram showing the video processing method on interlaced frames within P frames according to an exemplary embodiment of the present invention.

FIG. 8 is a diagram showing the video processing method on interlaced frames within B frames according to an exemplary embodiment of the present invention.

FIG. 9 is a timing diagram of the pipeline stages of a video processor according to another exemplary embodiment of the present invention.

### DESCRIPTION OF THE EXEMPLARY EMBODIMENTS

Reference will now be made in detail to the present exemplary embodiments of the invention, examples of which are illustrated in the accompanying drawings. Wherever possible, the same reference numbers are used in the drawings and the description to refer to the same or like parts.

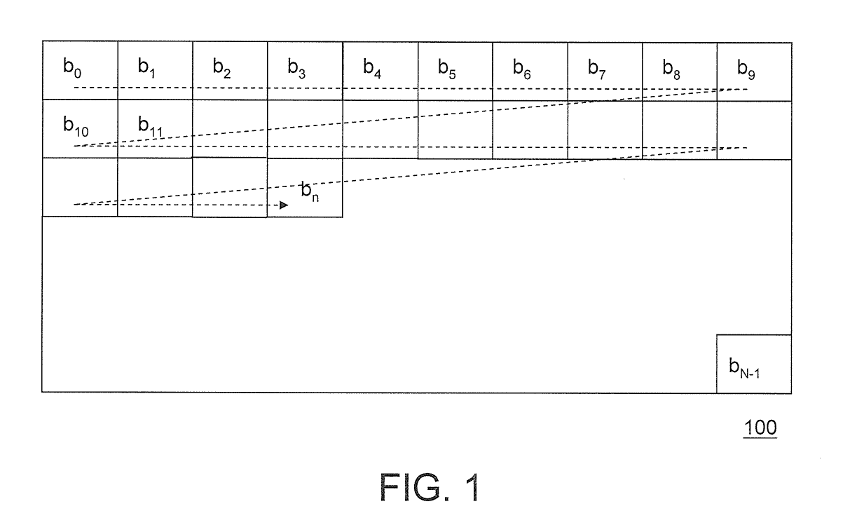

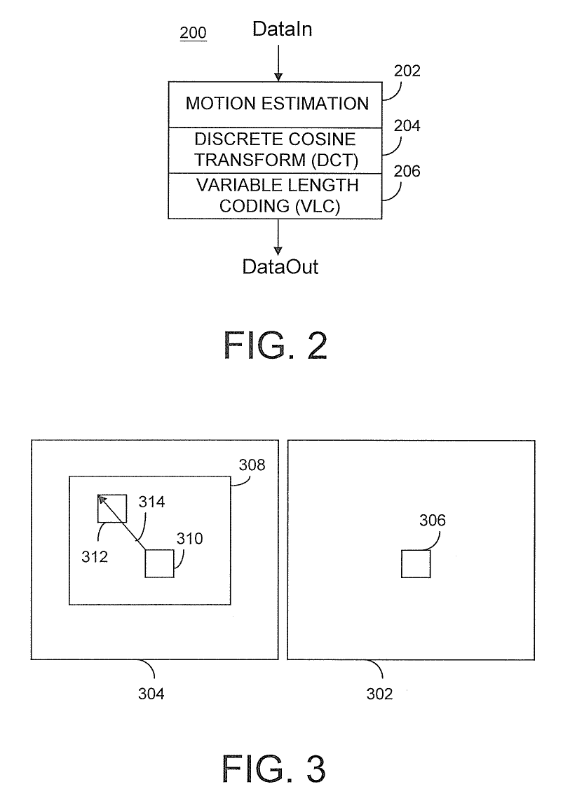

During video processing, every frame in a video stream would be decomposed into a plurality of MBs firstly. The decomposed frames are shown by FIG. 1, wherein a frame 100 is decomposed into N MBs b₀-b_{N-1} and the decomposing sequence is the same as the raster order. On the other hand, the whole video processing program can be divided into a plurality of stages. FIG. 2 is a diagram showing the stages of the main program for video processing. A main program of video processing 200 is divided into three stages: motion estimation 202, discrete cosine transform (DCT) 204 and variable length coding (VLC) 206. In this way, a data-inputting terminal DataIn sequentially inputs the MBs b0-bN−1 into the three stages, while the result of the video processing is output to a data-outputting terminal DataOut.

During the video processing, the motion estimation functions to define the range of the search window within a reference frame according to the positions of the MBs within a current frame to be coded and to find out a reference MB within the search window. FIG. 3 is a diagram illustrating motion estimation. Referring to FIG. 3, a current frame to be coded 302 contains a MB 306 and the reference frame 304 contains the corresponding MB 310, wherein the corresponding MB 310 within the reference frame 304 and the MB 306 within the current frame to be coded 302 are co-located. The reference frame 304 would define the range of the search window 308 according to the position of the corresponding MB 310. Thereby, the motion estimation processing can accomplish the above-mentioned function of finding out a reference MB 312 within the search window 308, wherein the difference value between the reference MB 312 and the MB 306 is the minimum, and the shift value of the MB 306 relative to the reference MB 312 is termed as motion vector 314.

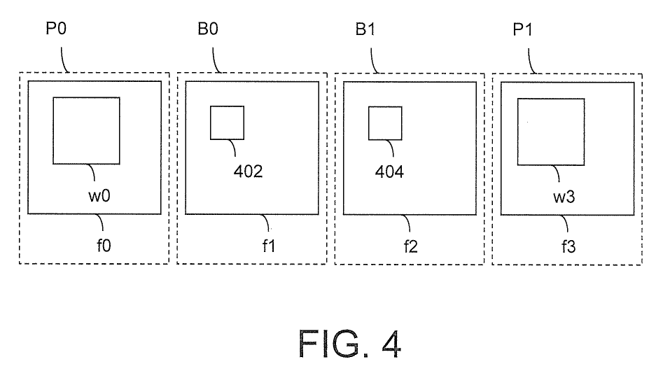

During motion estimation, tremendous operations of reading data and writing data are performed on a memory. In order to reduce the required memory bandwidth, the search window is repeatedly used by design so as to lower down the required memory bandwidth. FIG. 4 is a diagram showing the video processing method on progressive frames according to an exemplary embodiment of the present invention. Referring to FIG. 4, all the lines in each frame herein are transmitted in progressive mode, wherein the current frame to be coded f1 and the current frame to be coded f2 are B frames, both of them have no data dependence on each other, and the reference frame f0 and the reference frame f3 are P frames. The description “no data dependence on each other between current frames to be coded” is well known by anyone skilled in the art, which therefore, is omitted to describe. The reference frame f1 contains a MB 402. In order to perform motion estimation on the MB 402, a search window w0 within the reference frame f0 and a search window w3 within the reference frame f3 are used. On the other hand, the current frame to be coded f1 contains the MB 402, and the position of the MB 402 within the current frame to be coded f1 and the position of a MB 404 within the current frame to be coded f2 are co-located, which suggests the plurality of search windows used for motion estimation on the MB 404 are the same as the search windows w0 and w3 used for motion estimation on the MB 402.

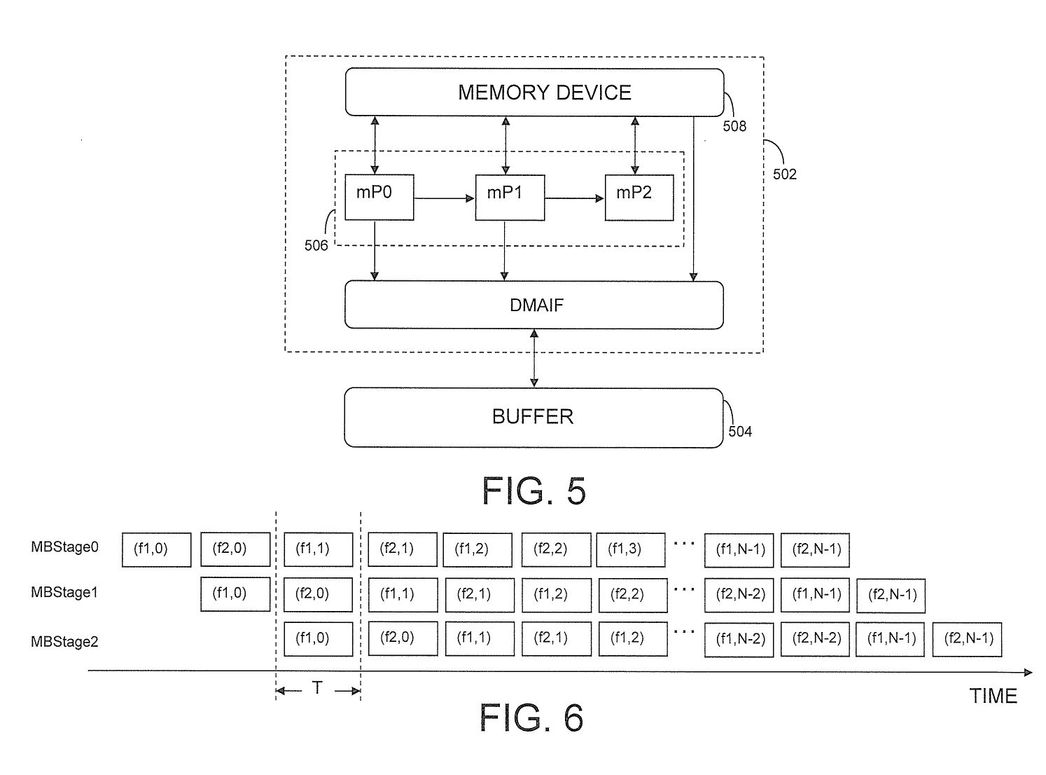

According the described above, if the MBs are co-located respectively within a plurality of current frames to be coded and they have no data dependence on each other between the above-mentioned current frames to be coded, the same search windows can be used to perform motion estimation on the MBs. In other words, once the plurality of search windows are read and saved in a memory device (not shown) from a buffer (not shown), the search windows can be used for the current frames to be coded to perform motion estimation. Continuing to FIG. 2, since the main program of video processing can be decomposed into a plurality of stages, the video processor can be designed as a plurality of pipelined processing devices. Based on the above-mentioned idea, a block diagram of a video processor according to an exemplary embodiment of the present invention is provided, as shown by FIG. 5.

Referring to FIG. 5, a video processor 502 is coupled to a buffer 504 and includes a memory device 508, a direct-memory-access interface DMAIF and an image encoder 506. The video processor 502 accesses the buffer 504 through the direct-memory-access interface DMAIF for fast reading and saving the memory data and temporally saves the read out data in the memory device 508 to facilitate the processing of the image encoder 506. In addition, the processing result of the image encoder 506 can be output to the buffer 504 through the direct-memory-access interface DMAIF as well. On the other hand, since the main program of video processing 200 can be decomposed into three stages, so that the image encoder 506 can be designed in this way that three processing devices mP0-mP2 are respectively disposed at each of the three stages, wherein the processing device mP0 executes motion estimation, the processing device mP1 executes DCT and the processing device mP2 executes VLC.

The video processor 502 can comprise a plurality of pipelined processing devices by design, and the processing devices sequentially receive and process a plurality of MBs. In this regard, the video processing timing of the video processor 502 can be represented by the timing of the above-mentioned pipelined stages. FIG. 6 is a timing diagram of the pipeline stages of a video processor according to an exemplary embodiment of the present invention. Referring to FIG. 6, each block in FIG. 6 represents an MB to be processed by one of the above-mentioned processing devices, and the n-th MB within the current frame to be coded f can be represents by a number-pair (f, n). For example, the first MB within the current frame to be coded f2 can be represents by a number-pair (f2, 1), and analogically for the rest.

Referring to FIGS. 5 and 6, the MB stage MBStage 0 in FIG. 6 represents the processing device mP0 executes the assigned function (motion estimation), the MB stage MB Stage 1 represents the processing device mP1 executes the assigned function (DCT) and the MB stage MBStage 2 represents the processing device mP2 executes the assigned function (VLC). In terms of time sequence, the processing device mP0 firstly processes the MB (f1, 0) and then processes the MB (f2, 0), and analogically for the rest. In more details, the position of the MB (f1, 0) within the current frame to be coded f1 and the position of the MB (f2, 0) within the current frame to be coded f2 are co-located, so that the two MBs (f1, 0) and (f2, 0) use the same search windows for motion estimation. In other words, when a plurality of search windows used by the MB (f1, 0) are read from the buffer 504 and saved into the memory device 508, the search windows can be shared by the MB (f1, 0) and the MB (f2, 0) for the usages. In this way, in order to perform motion estimation on the MB (f2, 0), there is no need to read the above-mentioned search windows again, which contributes saving the bandwidth of memory for motion estimation.

Another advantage of the pipeline design is that after the processing device mP0 completes the processing on the MB (f1, 0), the processing device mP1 successively processes the MB (f1, 0); after the processing device mP1 completes the processing on the MB (f1, 0), the processing device mP2 successively processes the MB (f1, 0). In this way, during the video processor 502 executes video processing, the processing devices mP0-mP2 can efficiently and simultaneously execute the their own functions in a unit time, which not only saves the bandwidth of memory for motion estimation, but also enables simultaneously processing a plurality of frames.

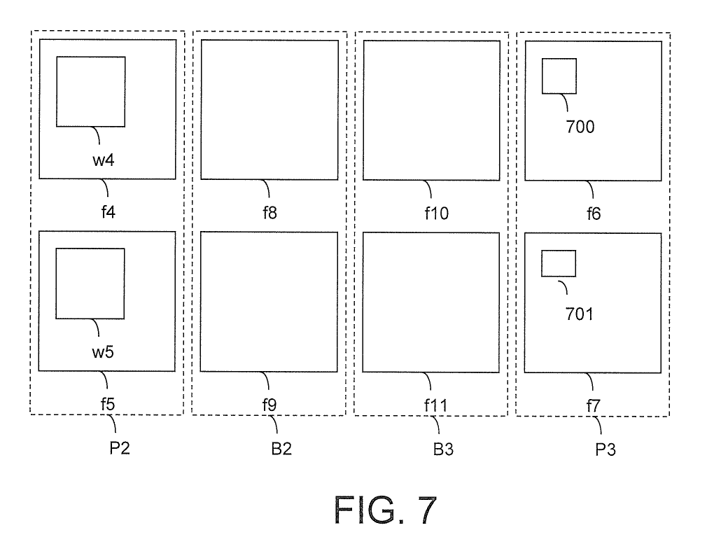

The video processing method of the present invention not only can process progressive frames, but also can process interlaced frames. FIG. 7 is a diagram showing the video processing method on interlaced frames within P frames according to an exemplary embodiment of the present invention. Referring to FIG. 7, in the exemplary embodiment, the field frames f6 and f7 within the P frame P3 are two current frames to be coded, and a plurality of current frames to be coded have no data dependence on each other. Within the P frame P2, the field frames f4 and f5 are reference frames. When performing motion estimation on the MB 700 within the field frame f6 and the MB 701 within the field frame f7, both the field frames f4 and f5 are used. In more details, since the position of the MB 700 within the current frame to be coded f6 and the position of the MB 701 within the current frame to be coded f7 are co-located, so that the search ranges used to perform motion estimation on the two MBs 700 and 701 are just the search window w4 within the field frame f4 and the search window w5 within the field frame f5. On the other words, when both the search windows w4 and w5 are read out from the buffer 504 and saved into the memory device 508, both the search windows w4 and w5 are shared by the MBs 700 and 701 for usages, where there is no need to read the above-mentioned search windows again, which contributes saving the bandwidth of memory for motion estimation.

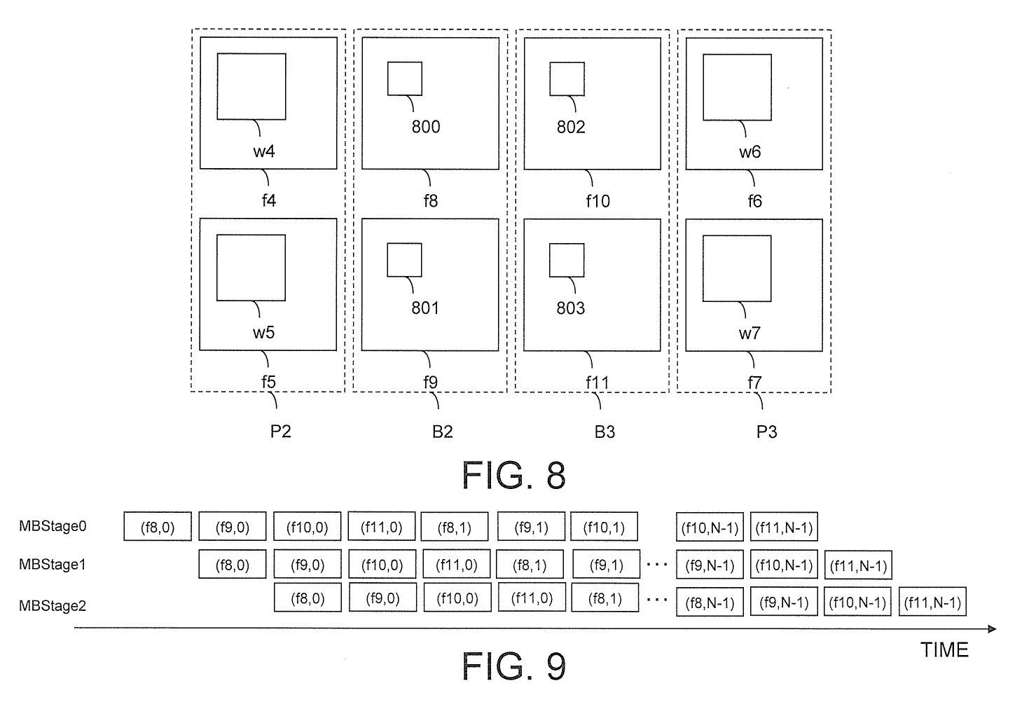

FIG. 8 is a diagram showing the video processing method on interlaced frames within B frames according to an exemplary embodiment of the present invention. Referring to FIG. 8, the P frame P2 contains a field frame f4 and another field frame f5, the P frame P3 contains a field frame f6 and another field frame f7, the B frame B2 contains a field frame f8 and another field frame f9, and the B frame B3 contains a field frame f10 and another field frame f11. In the exemplary embodiment, the field frames f8-f11 are the current frames to be coded, and a plurality of current frames to be coded have no data dependence on each other. The field frames f4-f7 are reference frames. When performing motion estimation on the MBs 800-803 within the field frames f8-f11, the field frames f4-f7 are used. In more details, since the position of the MB 800 within the current frame to be coded f8, the position of the MB 801 within the current frame to be coded f9, the position of the MB 802 within the current frame to be coded f10, and the position of the MB 803 within the current frame to be coded f11 are co-located, so that the search ranges used to perform motion estimation on the two MBs 800-803 are just the search windows w4-w7 within the field frames f4-f7. On the other words, when the search windows w4-w7 are read out from the buffer 504 and saved into the memory device 508, the search windows w4-w7 are shared by the MBs 800-803 for usages. In the exemplary embodiment, the more the MBs being co-located, the more significant the effect of saving the bandwidth of memory for motion estimation is.

FIG. 9 is a timing diagram of the pipeline stages of a video processor according to another exemplary embodiment of the present invention. Referring to FIG. 9, similarly to FIG. 6, each block in FIG. 9 represents an MB to be processed by one of the above-mentioned processing devices, and the n-th MB within the current frame to be coded f can be represents by a number-pair (f, n). For example, the first MB within the current frame to be coded f9 can be represents by a number-pair (f9, 0) so that the first MB can be termed as the MB (f9, 0), and analogically for the rest. On the other hand, the MB stages MBStage 0-MBStage 1 are defined similarly to FIG. 6. In more details, the position of the MB (f8, 0) within the current frame to be coded f8, the position of the MB (f9, 0) within the current frame to be coded f9, the position of the MB (f10, 0) within the current frame to be coded f10, and the position of the MB (f11, 0) within the current frame to be coded f11 are co-located, so that the four MBs use the same search windows for motion estimation. In other words, when a plurality of search windows used by the MB (f8, 0) are read from the buffer 504 and saved into the memory device 508, the search windows can be shared by the MB (f8, 0), the MB (f9, 0), the MB (f10, 0) and the MB (f11, 0) for the usages. In this way, in order to perform motion estimation on the MBs (f9, 0) (f10, 0) and (f11, 0), there is no need to read the above-mentioned search windows again, which means the video processing method and the video processor of the exemplary embodiment is advantageous not only in saving the bandwidth of memory for motion estimation, but also in ability of simultaneously processing a plurality of frames.

In summary, in the video processing method and the video processor of the present invention, since the plurality of MBs within a plurality of current frames to be coded are co-located, so that during designing motion estimation, the buffer is needed to read a plurality of search windows once to meet the requirement by a plurality of MBs for performing motion estimation, wherein the more the MBs being co-located, the more significant the effect of saving the bandwidth of memory for motion estimation is. In addition, since the video processor is designed as a plurality of pipelined processing devices, so that the processing devices can efficiently and simultaneously execute individual functions in a unit time, which is advantageous in not only saving the memory bandwidth of motion estimation, but also simultaneously processing a plurality of frames.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. A video processing method, comprising:
(a) reading a plurality of current frames to be coded from a buffer, wherein each current frame to be coded comprises a plurality of macroblocks;
(b) reading x search windows from the buffer, wherein x is a positive integer greater than 0;
(c) in a processing device, performing motion estimation within the x search windows on the m-th macroblock of the i-th current frame to be coded of the current frames to be coded; and
(d) in the processing device, performing motion estimation within the x search windows on the n-th macroblock of the j-th current frame to be coded of the current frames to be coded.

2. The video processing method as claimed in claim 1, wherein i is not equal to j.

3. The video processing method as claimed in claim 1, wherein the m-th macroblock within the i-th current frame to be coded and the n-th macroblock within the j-th current frame are co-located.

4. The video processing method as claimed in claim 3, wherein i is not equal to j.

5. The video processing method as claimed in claim 1, wherein the current frames to be coded have no data dependence on each other.

6. The video processing method as claimed in claim 1, wherein the motion estimation is used to obtain a plurality of reference macroblocks and a plurality of motion vectors corresponding to the macroblocks.

7. The video processing method as claimed in claim 1, wherein the step (c) comprises:
(e) using the processing device to search a reference macroblock within the x search windows, wherein the difference value between the reference macroblock and the m-th macroblock is the minimum; and
(f) calculating a motion vector, wherein the motion vector is a shift value of the m-th macroblock relative to the reference macroblock.

8. The video processing method as claimed in claim 1, wherein the video processing method further comprises repeatedly executing the step cycle from step (b) to step (d).

9. The video processing method as claimed in claim 1, wherein the current frames to be coded are a plurality of B frames, a plurality of P frames or a plurality of combinations thereof.

10. A video processor, coupled to a buffer, wherein the video processor reads a plurality of current frames to be coded from the buffer and each of the current frames to be coded comprises a plurality of macroblocks; the video processor comprising:
a memory device, for reading x search windows from the buffer, wherein x is a positive integer greater than zero; and
a processing devices, performing motion estimation within the x search windows on the m-th macroblock of the i-th current frame to be coded of the current frames to be coded, and performing motion estimation within the x search windows on the n-th macroblock of the j-th current frame to be coded of the current frames to be coded.

11. The video processor as claimed in claim 10, wherein i is not equal to j.

12. The video processor as claimed in claim 10, wherein the m-th macroblock within the i-th current frame to be coded and the n-th macroblock within the j-th current frame are co-located.

13. The video processor as claimed in claim 12, wherein i is not equal to j.

14. The video processor as claimed in claim 10, wherein the current frames to be coded have no data dependence on each other.

15. The video processor as claimed in claim 10, wherein the motion estimation is used to obtain a plurality of reference macroblocks and a plurality of motion vectors corresponding to the macroblocks.

16. The video processor as claimed in claim 10, wherein the current frames to be coded are a plurality of B frames, a plurality of P frames or a plurality of combinations thereof.

17. A video processing method, comprising:
(a) reading the i-th macroblock of each of p current frames to be coded by a processing device, wherein each of the current frames to be coded comprises a plurality of macroblocks and p is a positive integer greater than 1; and
(b) transmitting the i-th macroblocks to an image encoder.

18. The video processing method as claimed in claim 17, wherein the i-th macroblock within each of the current frames to be coded is co-located as those within the other current frames to be coded.

19. The video processing method as claimed in claim 17, further comprising:
(c) reading x search windows by the processing device, wherein x is a positive integer greater than zero; and
(d) in the image encoder, performing motion estimation on the i-th macroblocks within the x search windows.

20. The video processing method as claimed in claim 17, wherein the video processing method further comprises repeatedly executing the step cycle from step (a) to step (b).

21. A video processor, comprising:
a processing device, for reading the i-th macroblock from each of p current frames to be coded, wherein each of the current frames to be coded comprises a plurality of macroblocks and p is a positive integer greater than 1; and
an image encoder, for receiving the i-th macroblocks and performing image coding processing.

22. The video processor as claimed in claim 21, wherein the i-th macroblock within each of the current frames to be coded is co-located as those within the other current frames to be coded.

23. The video processor as claimed in claim 21, wherein the processing device is for reading x search windows, wherein x is a positive integer greater than zero; the image encoder performs motion estimation on the i-th macroblocks within the x search windows.
